(19) United States
(12) Patent Application Publication
(10) Pub. No.: US 2004/0062573 A1
(43) Pub. Date: Apr. 1, 2004

(54) Process cartridge and image forming apparatus

(75) Inventors: Kenji Matsuda, Numazu-shi (JP); Akiyoshi Fujita, Numazu-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/670,235

(22) Filed: Sep. 26, 2003

(30) Foreign Application Priority Data
Sep. 30, 2002 (JP) 2002-287438

(51) Int. Cl. G03G 15/08

(52) U.S. Cl. 399/258

(57) ABSTRACT

A cartridge detachably mountable to a main assembly of an electrophotographic image forming apparatus, said cartridge includes a developer accommodating portion for accommodating a developer; a developer supply port for supplying the developer to developing means for developing an electrostatic latent image formed on an electrophotographic photosensitive member; a removable sealing tape for sealing said developer supply port; a covering member which is capable of taking an opening position f or opening said developer supply port and a closing position for closing said developer supply port and to which one longitudinal end of said sealing tape is fixed, said covering member is effective to cover said sealing tape sealing said developer supply port when it is at the closing position; a cartridge locking portion for locking said covering member at the closing position; wherein when said cartridge is mounted to the main assembly of the apparatus, locking between said cartridge locking portion and said covering member is released by engagement between said covering member and the main assembly of the apparatus, and said covering member moves from said closing position to said opening position, and said sealing tape is removed from said developer supply port to open said developer supply port.

### FIELD OF THE INVENTION AND RELATED ART

The present invention relates to a cartridge removably mountable in the main assembly of an electrophotographic image forming apparatus, and an electrophotographic image forming apparatus in which the cartridge is removably mountable.

A cartridge removably mountable in the main assembly of an electrophotographic image forming apparatus has been widely known (for example, Japanese Laid-open Patent Application 2000-221854). Here, an electrophotographic image forming apparatus means an apparatus for forming an image on recording medium with the use of an electrophotographic image forming method. As examples of an electrophotographic image forming apparatus, there are electrophotographic copying machines, electrophotographic printers (laser beam printers, LED printers, etc.), facsimileing machines, word processors, etc.

A cartridge means a cartridge having a minimum of a storage portion for storing developer used by a developing means. There is a cartridge system in which a cartridge is removably mounted in the main assembly of an electrophotographic image forming apparatus. It has been in use in recent years.

A cartridge system substantially improved an electrophotographic image forming apparatus in operability. In particular, it made it possible for a user to maintain by himself the components of an electrophotographic image forming apparatus, which contribute to the image formation process. Thus, a cartridge system has come to be widely used in the field of an image forming apparatus.

Some of the image forming apparatus components which directly contribute to an image formation process are longer in service life than the others. Therefore, such a cartridge system has been realized that the components with a shorter service life are placed in one type of a cartridge, and the components with a longer service life are placed in another type of cartridge. For example, a development cartridge (development unit) in which a developer storage portion and a developing means are integrally disposed in a cartridge, a drum cartridge (drum unit) in which an electrophotographic photoconductive member (photoconductive drum), a charging means, and a cleaning means, are integrally disposed in a cartridge, and the like cartridges, are currently in use.

A cartridge having a developer storage portion for storing developer has an outlet (discharge hole) through which the developer in the developer storage portion is supplied (discharged) to a developing means. It is a common practice to keep this outlet sealed with a sealing tape which can be peeled. This practice has an advantage in that it can prevent the toner deterioration in a developer storage portion. When a cartridge sealed with the above described method is put to use by a user, the user is to remove this sealing tape to expose the opening of the outlet so that the cartridge can be used.

It is not unreasonable to think that it is feasible to provide a cartridge, the developer outlet of which is kept sealed with a sealing tape until the cartridge is used for the very first time, with such a structural arrangement that the sealing tape is automatically peeled away by the mounting of the cartridge into the main assembly of an image forming apparatus.

For example, the sealing tape can be automatically peeled by providing a cartridge with a cartridge cover which is moved by the mounting movement of the cartridge, and fixing one end of the sealing tape to the cartridge cover. With this structural arrangement, as the cartridge cover is moved by the mounting movement, of the cartridge, the sealing tape is peeled by the movement of the cartridge cover.

This structural arrangement, however, causes concern in that a cartridge is sometimes subjected to shocks during shipment or the like, that is, before it is used for the very first time, and as a cartridge is subjected to shocks or the like, its cartridge cover is moved by the shocks, peeling thereby the sealing tape, allowing thereby developer to leak.

### SUMMARY OF THE INVENTION

The primary object of the present invention is to provide a cartridge, the sealing tape of which is easily removably before it is used for the very first time, and an electrophotographic image forming apparatus in which said cartridge is removably mountable.

Another object of the present invention is to provide a cartridge which does not have the problem that the developer therein leaks due to an accidental removal of its sealing tape, and an electrophotographic image forming apparatus in which said cartridge is removably mountable.

Another object of the present invention is to provide a cartridge which can be reduced in size, and an electrophotographic image forming apparatus in which the cartridge is removably mountable.

Another object of the present invention is to provide a cartridge, the cover of which smoothly moves when the cartridge is mounted into the main assembly of an electrophotographic image forming apparatus, and an electrophotographic image forming apparatus in which the cartridge is removably mountable.

Another object of the present invention is to provide a cartridge which is removably mountable in the main assembly of an electrophotographic image forming apparatus, and comprises: a developer storage portion for storing developer; a developer outlet through which the developer in the developer storage portion is supplied to a developing means for developing an electrostatic latent image formed on an electrophotographic photoconductive member; a removable sealing tape for sealing the developer outlet; a covering member, which is capable of taking the open position in which it exposes the developer outlet, and the closed position in which it seals the developer outlet, and covers the sealing tape, and to which one end of the sealing tape is fixed; and the covering member retaining portion for retaining the covering member in the closed position; wherein the covering member is disengaged from the covering member retaining portion by the engagement of the covering member with the main assembly of the image forming apparatus, which occurs during the initial stage of the insertion of the cartridge into the main assembly of the image forming apparatus, and the sealing tape is removed, exposing thereby the opening of the developer outlet, by the movement of the covering member from the closed position to the opening position, which occurs after the initial stage of the insertion of the cartridge into the apparatus main assembly.

Another object of the present invention is to provide an electrophotographic image forming apparatus in which a cartridge is removably mountable, and which is for forming an image on recording medium, comprising: (i) a mounting means for removably mounting a cartridge comprising: a developer storage portion for storing developer; a developer outlet through which the developer in the developer storage portion is supplied to a developing means for developing an electrostatic latent image formed on an electrophotographic photoconductive member; a removable sealing tape for sealing the developer outlet; a covering member which is capable of taking the open position in which its exposes the developer outlet, and the closed position in which it seals the developer outlet, and covers the sealing tape, and to which one end of the sealing tape is fixed; and the covering member retaining portion for retaining the covering member in the closed position; and (ii) a conveying means for conveying recording medium; wherein the covering member of the cartridge is disengaged from the covering member retaining portion by the engagement of the covering member with the main assembly of the image forming apparatus, which occurs during the initial stage of the insertion of the cartridge into the main assembly of the image forming apparatus, and the sealing tape is removed, exposing thereby the opening of the developer outlet, by the movement of the covering member from the closed position to the opening position, which occurs after the initial stage of the insertion of the cartridge into the apparatus main assembly.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a vertical sectional view of the image forming apparatus in the first embodiment of the present invention.

FIG. 2 is a vertical sectional view of the process cartridge and toner supply container in the first embodiment of the present invention.

FIG. 3 is a schematic perspective view of the image forming apparatus in the first embodiment of the present invention, the front door of which is open.

FIG. 4 is a vertical sectional view of the process cartridge in the first embodiment of the present invention, parallel to the lengthwise direction of the process cartridge.

FIG. 5 is a vertical sectional view of the combination of the toner supply container and process cartridge in the first embodiment of the present invention, parallel to the lengthwise direction of the combination.

FIG. 6 is a perspective view of the toner supply container in the first embodiment of the present invention, the outlet cover of which is closed.

FIG. 7 is a perspective view of the toner supply container in the first embodiment of the present invention, which is being inserted into the main assembly of an image forming apparatus.

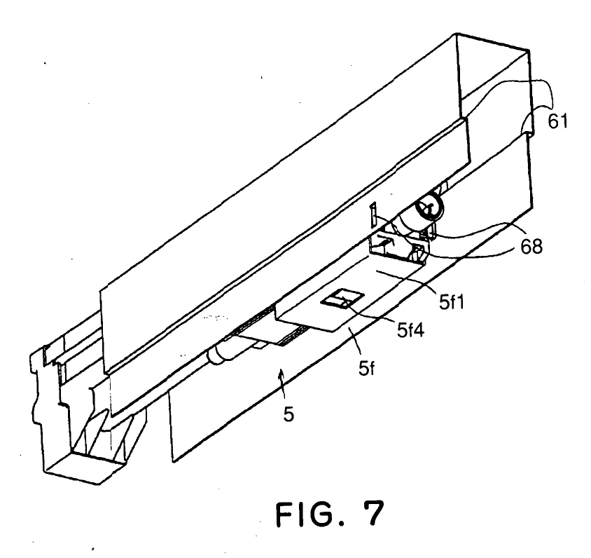

FIG. 8 is a drawing for showing the movements of the outlet cover during the insertion of the toner supply container into the main assembly of an image forming apparatus.

FIG. 9 is an enlarged perspective view of the outlet portion of the toner supply container, and its adjacencies, in the first embodiment of the present invention, with the outlet cover being closed.

FIG. 10 is an enlarged perspective view of the outlet portion of the toner supply container, and its adjacencies, in the first embodiment of the present invention, with the outlet cover being open.

FIG. 11 is an enlarged side view of the outlet cover of the toner supply container, and the means for retaining the outlet cover in place, in the first embodiment of the present invention.

FIG. 12 is an enlarged view of the first portion of the outlet cover retaining means, in the first embodiment of the present invention.

FIG. 13 is an enlarged view of the second portion of the outlet cover retaining means, in the first embodiment of the present invention, FIG. 13(A) being the view seen from below (right side) thereof, and FIG. 13(B) being the view of the circled area in FIG. 11(A) seen from the direction indicated by an arrow mark V.

FIG. 14 is an enlarged view of the third portion of the outlet cover retaining means, in the first embodiment of the present invention.

FIG. 15 is an enlarged view of the means for retaining the outlet cover in place, in the second embodiment of the present invention.

### DESCRIPTION OF THE PREFERRED EMBODIMENTS

Hereinafter, the preferred embodiments of the present invention will be described in detail with reference to the appended drawings. Incidentally, the measurements, materials, shapes, of the structural components, the positional relationship among them, etc., in the following embodiments of the present invention are not intended to limit the scope of the present invention, unless specifically noted.

In the following descriptions of the present invention, the lengthwise direction means a direction parallel to the axial direction of an electrophoto graphic photoconductive drum (which hereinafter will be referred to as photoconductive drum 2). Further, with reference to the direction in which a cartridge is inserted into an electrophotographic image forming apparatus, the side toward which a cartridge is inserted will be referred to as the back side, and the side toward which a cartridge is extracted (upstream side with reference to cartridge insertion direction) will be referred to as the front side. Further, the top or bottom side of a cartridge means the top or bottom side of a cartridge properly disposed in the main assembly of an electrophotographic image forming apparatus.

### General Description of Image Forming Apparatus

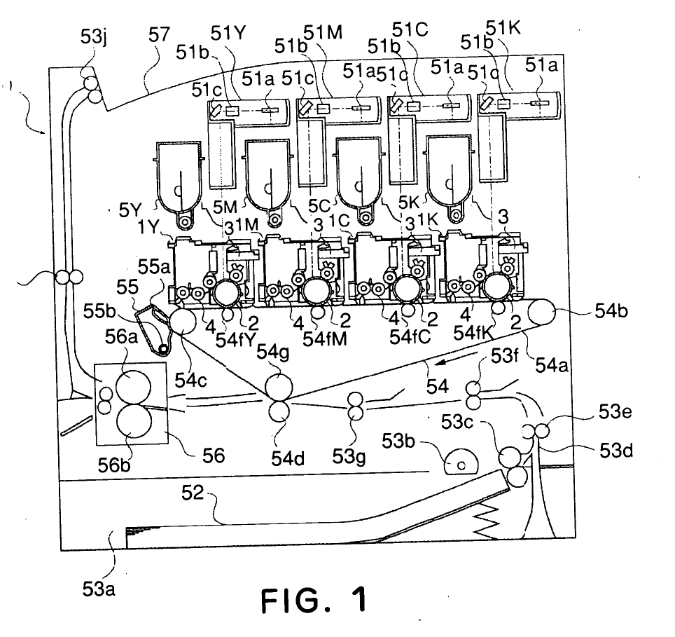

First, referring to FIG. 1, the general structure of a typical electrophotographic color image forming apparatus will be described. FIG. 1 is a drawing for describing the general structure of a color laser beam printer (which hereinafter may be simply referred to as image forming apparatus), that is, one form of an electrophotographic color image forming apparatus.

The image forming portion of this color laser beam printer in this embodiment employs four process cartridges 1 (1Y, 1M, 1C, and 1K corresponding to yellow, magenta, cyan, and black color components, respectively), each of which has a photoconductive drum 2 as an image bearing member. The image forming portion also has four exposing means (laser beam optical scanning system) 51 (51Y, 51M, 51C, and 51K), which are disposed in parallel and are aligned in the horizontal direction. The four exposing means 1 are located above the process cartridges 1 (1Y, 1M, 1C, and 1K), being roughly vertically aligned one for one with the four process cartridges 1.

Disposed below the above described image forming portion is a feeding means for feeding a recording medium 52 into the main assembly, an intermediary transfer belt 54a onto which a toner image formed on the photoconductive drum 2 is transferred, and a secondary transfer roller 54d for transferring the toner images on the transfer belt 4a, onto the recording medium 52 on the intermediary transfer belt 54a.

The image forming apparatus is also provided with a fixing means for fixing the toner images which have been transferred onto the recording medium 52, and a discharging means for discharging the recording medium 52 out of the image forming apparatus main assembly and accumulating it. The recording medium 52 is, for example, a piece of recording paper, OHP sheet, fabric, or the like.

The image forming apparatus in this embodiment is a cleaner-less apparatus. Thus, the transfer residual toner, that is, the toner remaining on the photoconductive drum 2 after transfer is taken in by the developing means. Therefore, the process cartridge 1 is not provided with a cleaner dedicated to the recovery and storage of the transfer residual toner.

Next, the structures of the various portions of the image forming apparatus will be described in detail in the logical order.

### Feeding Portion

The feeding portion is a portion for conveying the recording medium 52 to the image forming portion. It essentially comprises: a feeding cassette 53a which holds a plurality of recording mediums 52; a feed roller 53b; a pair of retard rollers 53c for preventing two or more recording mediums 52 from being fed at the same time; a guide 53d; and a pair of registration rollers 53g.

The feeding roller 53b is rotationally driven in synchronism with an image forming operation, taking the recording mediums 52, virtually one by one, out of the feeding cassette 53a and feeding them into the apparatus main assembly. As the recording mediums 52 are fed into the apparatus main assembly, they are prevented by the retard rollers 53c from being fed at the same time. Then, the recording mediums 52 are conveyed to the registration rollers 53g, by way of conveyance rollers 53e and 53f, while being guided by the conveyance guide 53d.

During an image forming operation, the registration rollers 53g repeat the sequence of being kept stationary for keeping a recording medium 52 on standby, and being rotated for conveying the recording medium 52 toward the intermediary transfer belt 54a, in order to align a toner image with the recording medium 52 during the subsequent transfer process.

Immediately after the release of the recording medium 52, the rotation of the registration rollers 53g is stopped, and the registration rollers 53g are again kept stationary. Then, the following recording medium 52 collides with the nip portion between the two registration rollers 53g, being thereby unslanted.

### Process Cartridge

A process cartridge means a cartridge in which a charging means, and a developing meaning or cleaning means, are integrally disposed along with an electrophotographic photoconductive drum, and which is removably mountable in the main assembly of an electrophotographic image forming apparatus, or a cartridge in which at least one means among a charging means, a developing means, and a cleaning means, is integrally disposed along with an electrophotographic photoconductive drum, and which is removably mountable in the main assembly of an electrophotographic image forming apparatus. It also means a cartridge in which a minimum of a developing means is integrally disposed along with an electrophotographic photoconductive drum, and which is removably mountable in the main assembly of an electrophotographic image forming apparatus.

In this embodiment, the image forming apparatus 100 employs a cleaner-less system. Thus, the process cartridges 1Y, 1M, 1C, and 1K for this image forming apparatus are cartridges in which a charging means and developing means are integrally disposed along with an electrophotographic photoconductive drum, and which are removably mountable in the main assembly (which hereinafter will be referred to as apparatus main assembly 100) of the image forming apparatus 100.

In each of the process cartridges 1Y, 1M, 1C, and 1B, a charging means and a developing means are integrally disposed around the peripheral surface of the photoconductive drum 2. These process cartridges 1 are structured so that they can be removably mountable in the apparatus main assembly 100. Therefore, they can be easily removed from the image forming apparatus 100, and are to be replaced at the end of the service life of the photoconductive drum 2.

As for the method for determining whether or not the service life of the process cartridge 1 has reached its end, the rotations of the photoconductive drum 2 are counted, and as the cumulative number of the rotations exceeds a predetermined value, a user is warned that the service life of the process cartridge 1 has reached its end. Obviously, the determining method does not need to be limited to the above described one; other methods may be employed.

The photoconductive drum 2 in this embodiment is an organic photoconductive member, the inherent polarity of which is negative. More specifically, it comprises a hollow aluminum cylinder, as a base member 2h, with a diameter of approximately 30 mm, a layer of an ordinary photoconductive substance coated on the peripheral surface of the base member 2h, and a charge injection layer as an outermost layer coated on the photoconductive layer. It is rotationally driven at a predetermined process speed, which in this embodiment is approximately 117 mm/sec.

The charge injection layer is a coated layer of a mixture of insulating resin as binder, and micro-particles of electrically conductive substance, for example, SnO₂, dispersed in the binder.

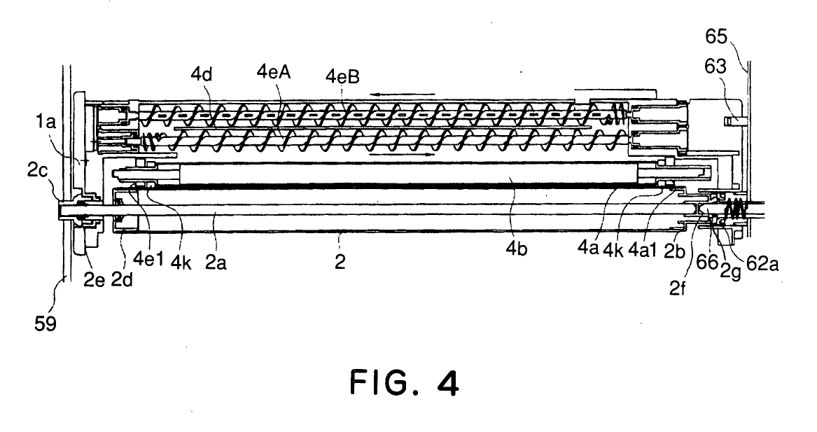

Referring to FIG. 4, the photoconductive drum 2 is provided with a drum flange 2b, which is solidly attached to the back end (right end in FIG. 4) of the base drum 2h of the photoconductive drum 2 in terms of the lengthwise direction of the photoconductive drum 2, and a drum flange 2d, which is solidly attached to the front end (left end in FIG. 4) of the base drum 2h, from which the photoconductive drum 2 is not driven. The photoconductive drum 2 is also provided with a drum shaft 2a, which penetrates the centers of the drum flanges 2b and 2d. The drum shaft 2a is connected to the flange 2d so that it rotates with the flange 2d, that is, the flange on the side from which the photoconductive drum 2 is not driven, which hereinafter will be referred to as non-driven flange 2d. The base drum 2h, drum shaft 2a, drum flange 2b, and non-driven flange 2d are rotated together. In other words, the photoconductive drum 2 is rotated about the axis of the drum shaft 2a.

The front end portion of the drum shaft 2a is rotationally supported by a bearing 2e, which is solidly fixed to a case 2c, which is solidly fixed to the frame 1a of the process cartridge 1.

### Charging Means

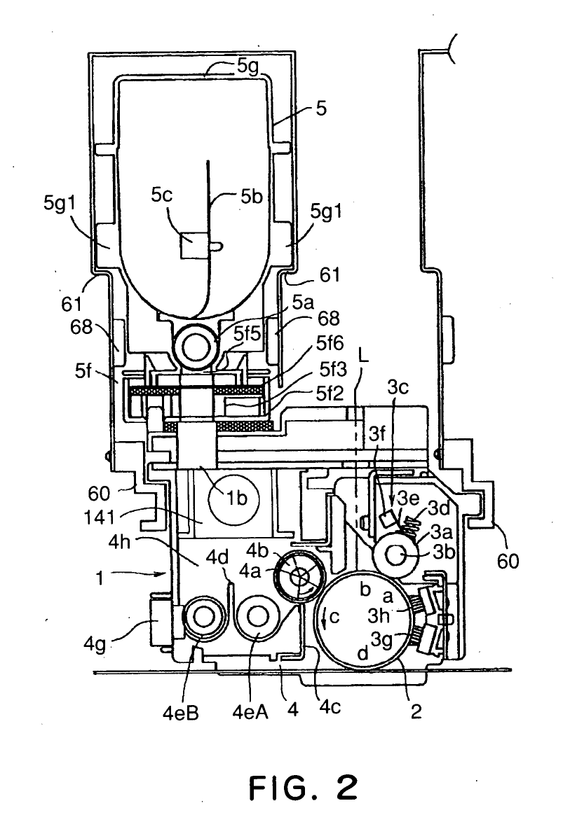

Referring to FIG. 2, the charging means in this embodiment employs one of the contact type charging methods. It employs a charge roller 3a as a charging member. The charge roller 3a is rotatably supported by a pair of bearings (unshown), at the lengthwise end portions of its metallic core 3b. It is kept pressured toward the photoconductive drum by a pair of compression springs 3d; it is kept in contact with the peripheral surface of the photoconductive drum 2, so that a predetermined amount of contact pressure is maintained between the photoconductive drum 2 and the charge roller 3a. It is rotated by the rotation of the photoconductive drum 2.

Designated by a referential number 3c is a cleaning member for cleaning the charge roller 3a. The charge roller cleaning member 3c in this embodiment has a flexible cleaning film 3e, which extends in the lengthwise direction of the charge roller 3a, in parallel to the charge roller 3a. The cleaning film 3e is solidly fixed, by one of the long edges thereof, to a supporting member 3f which is reciprocally moved a predetermined distance in the lengthwise direction of the charge roller 3a. The cleaning film 3e is disposed so that the free long edge portion of the cleaning film 3e forms a contact nip against the peripheral surface of the charge roller 3a.

With the provision of this structural arrangement, as the supporting member 3f is reciprocally moved by an external driving means (unshown), the peripheral surface of the charge roller 3a is rubbed by the cleaning film 3e. As a result, the contaminants (minute particles of toner, external additive, etc.) adhering to the peripheral surface of the charge roller 3a are removed.

Incidentally, the image forming apparatus in this embodiment is of a cleaner-less type. Next, the cleaner-less system will be described.

### Cleaner-Less System

Referring to FIG. 2, the outline of the cleaner-less system of the image forming apparatus in this embodiment will be described. According to the cleaner-less system in this embodiment, the transfer residual toner, that is, the toner remaining on the photoconductive drum 2 after the aforementioned toner image transfer is, generally, conveyed further by the subsequent rotation of the photoconductive drum 2 through the charging portion a and exposing portion b, and into the development portion c, in which the transfer residual toner is recovered (photoconductive drum is cleaned) by the developing means at the same time as a latent image on the photoconductive drum 2 is developed by the developing means.

Since the transfer residual toner on the peripheral surface of the photoconductive drum 2 is moved past the exposing portion b, the peripheral surface of the photoconductive drum 2 is exposed through the transfer residual toner thereon. However, the transfer residual toner is very small in quantity, not significantly affecting the exposing process.

In this embodiment, a transfer residual toner distributing means 3g (means for erasing residual developer image) for evenly distributing the transfer residual toner particles on the photoconductive drum 2, is disposed on the downstream side of the transfer portion d, in terms of the rotational direction of the photoconductive drum 2. Further, in order to make all the transfer residual toner particles normally charged, that is, negatively charged, a toner (developer) charge controlling means 3h for charging the reversely charged toner particles to negative polarity, is disposed between the downstream side of the transfer residual toner distributing means 3g, and the upstream side of the charging portion a, in terms of the rotational direction of the photoconductive drum 2.

With the provision of the transfer residual toner distributing means 3g, while the transfer residual toner particles, which are remaining, in a certain pattern, on the photoconductive drum 2, are conveyed from the transfer portion d to the toner charge controlling means 3h, they are evenly distributed across the peripheral surface of the photoconductive drum 2, losing therefore the pattern in which they have been adhering to the peripheral surface of the photoconductive drum 2, even if their amount is substantial. Therefore, the problem that the toner particles concentrate on certain portions of the toner charge controlling means 3h is eliminated, assuring thereby that the reversely charged residual toner particles are normally charged by the toner charge controlling means 3h so that all of the transfer residual toner particles become normal in polarity. Therefore, the adhesion of the transfer residual toner to the charge roller 3a is effectively prevented, and also the creation of a ghost image reflecting the pattern in which the transfer residual toner particles remain on the photoconductive drum 2 is prevented.

The transfer residual toner distributing means 3g and toner charge controlling means 3h, in this embodiment, are in the form of a brush with a proper degree of electrical conductivity, and are placed in contact with the photoconductive drum 2, with their brush portions in contact with the peripheral surface of the photoconductive drum 2.

These means 3g and 3h are structured so that they are moved (reciprocally) in the lengthwise direction of the photoconductive drum 2, by an unshown driving force source. With the provision of this structural arrangement, the transfer residual toner distributing means 3g and toner charge controlling means 3h do not remain in contact with the same ranges of the peripheral surface of the photoconductive drum 2. Therefore, it does not occur that a given portion of the peripheral surface of the photoconductive drum 2 is always contacted by the same portion of the toner charge controlling means 3h. Thus, even if the irregularity in electrical resistance across the toner charge controlling means 3h makes some portions of the toner charge controlling means 3h excessive in charging performance, and the other portions insufficient in charging performance, the problem that the excessively charged transfer residual toner particles adhere to certain areas of the peripheral surface of the photoconductive drum 2, and/or the problem that the insufficiently charged transfer residual toner particles adhere to certain areas of the peripheral surface of the charge roller 3a, are prevented or mitigated.

### Exposing Means

In this embodiment, the aforementioned photoconductive drum 2 is exposed by a laser exposing means. More specifically, as image formation signals are sent to the exposing means from the image forming apparatus main assembly 100, a beam of laser light L is projected from the exposing means, while being modulated with the image formation signals, onto the photoconductive drum 2, in a manner to scan the uniformly charged portion of the peripheral surface of the photoconductive drum 2, selectively exposing numerous points on the uniformly charged portion of the peripheral surface of the photoconductive drum 2. As a result, an electrostatic latent image in accordance with the image formation information is formed on the peripheral surface of the photo conductive drum 2.

Referring to FIG. 1, the laser exposing means comprises: a solid laser element (unshown), a polygon mirror 51a, a focusing lens 51b, a reflection mirror 51c, etc. In operation, the solid laser element is turned on and off by an optical signal generating device (unshown), in response to the inputted image formation signals. The beam of laser light L irradiated from the solid laser element is converted by a collimator lens system (unshown) into a beam of virtually parallel rays, and is projected onto. the polygon mirror 51a, which is being rotated at a high peripheral velocity. As a result, the beam of parallel rays is oscillated in a scanning manner. Then, it is further projected by way of the focusing lens 51b and reflection mirror 51c, forming an oscillating spot of light on the peripheral surface of the photoconductive drum 2.

Thus, as the spot of light oscillates, the peripheral surface of the photoconductive drum 2 is exposed in the primary scanning direction, and as the photoconductive drum 2 is rotated, it is exposed in the secondary scanning direction. As a result, numerous points on the peripheral surface of the photoconductive drum 2 are exposed or remain unexposed in such a manner that the distribution of the exposed and unexposed points reflects the image formation signal sequence. In other words, the points (exposed points) with the reduced potential level, and the points (unexposed points) with the normal potential level, are created, the contrast among which generates an electrostatic latent image in accordance with the image formation information.

### Developing Apparatus

The developing apparatus 4 is of a contact type developing apparatus which uses two-component developer (two-component magnetic brush type developing apparatus). Referring to FIG. 2, the developing apparatus 4 comprises a development sleeve 4a as a developer bearing member, and a magnetic roller 4b disposed within the hollow of the development sleeve 4a. The development sleeve 4a holds a layer of developer, which is a mixture of carrier and toner, on its peripheral surface. This development sleeve 4a is the actual developing means. The developing apparatus 4 also comprises a regulating blade 4c, which is disposed in the adjacencies of the peripheral surface of the development sleeve 4a, with the presence of a predetermined distance from the development sleeve 4a. As the development sleeve 4a is rotated in the direction indicated by an arrow mark, a thin layer of developer is formed on the peripheral surface of the development sleeve. Incidentally, the developing apparatus 4 in this embodiment is a two-component magnetic brush type developing apparatus. However, the developing apparatus 4 does not need to be of a two-component magnetic brush type.

Referring to FIG. 4, the development sleeve 4a is provided with a pair of ring-shaped spacers 4k, which are rotatably fitted around the journal portions 4a1, that is, the lengthwise end portions of the development sleeve 4a, one for one, which are smaller in diameter than the developer carrying portion of the development sleeve 4a. With the provision of the spacers 4k, a predetermined gap is maintained between the development sleeve 4a and photoconductive drum 2 so that during a development operation, only the developer layer formed on the peripheral surface of the development sleeve 4a touches the photoconductive drum 2. Referring to FIG. 2, the development sleeve 4a is rotationally driven in the counterclockwise direction indicated by an arrow mark at a predetermined peripheral velocity so that, in the development portion c, the peripheral surface of the development sleeve 4a moves in the direction counter to the moving direction of the peripheral surface of the photoconductive drum 2.

The toner in this embodiment is such toner that is negative in inherent polarity and is 6 μm in average particle diameter. The magnetic carrier in this embodiment is 205 emu/cm³ in saturation magnetization, and is 35 μm in average particle diameter. The ratio in weight between the toner and carrier in the developer is 6:94. However, the developer choice does not need to be limited to a mixture of toner and magnetic carrier. For example, magnetic toner may be used.

Referring to FIG. 2,. the developer storage portion 4h, in which the developer is circulated, has two chambers divided by a partitioning wall 4d which extends in the lengthwise direction, without touching the front and back walls of the developer storage portion. The developer storage portion 4h has stirring screws 4eA and 4eB, which are disposed on both sides of the partitioning wall 4d, one for one.

Referring to FIG. 4, as the toner is supplied to the developer storage portion 4h from the developer supply container (developer supplying apparatus) 5, the toner falls onto the back end portion (right end portion in FIG. 4) of the stirring screw 4eB, and the developer supplied with the toner is conveyed frontward (left end portion in FIG. 4) of the apparatus, in terms of the lengthwise direction, while being stirred. Then, it is moved through the gap between the front wall of the developer storage portion 4h and the partitioning wall 4d, and then, is conveyed backward (rightward in FIG. 4) of the developer storage portion 4h, in terms of the lengthwise direction, by the stirring screw 4eA. Then, it is moved through the gap between the back wall of the developer storage portion 4h and the partitioning wall 4d to be conveyed again frontward. In other words, the developer is repeatedly circulated by the stirring screws 4eB and 4eA in the developer storage portion 4h.

At this time, referring to FIG. 2, the development process for developing an electrostatic latent image formed on the photoconductive drum 2 into a visible image with the use of the developing apparatus 4 which employs a two-component magnetic brush developing method, and the developer circulating system, will be described.

As the development sleeve 4a is rotated, the developer in the developer storage portion 4h is picked up and held to the peripheral surface of the development sleeve 4a, by the pickup pole of the magnetic roller 4b, and is conveyed further.

While being conveyed after being held to the peripheral surface of the development sleeve 4a, the body of developer is regulated in thickness by the development blade 4c disposed perpendicular to the peripheral surface of the development sleeve 4a. As a result, a thin layer of developer is formed on the peripheral surface of the development sleeve 4a. As the thin layer of developer reaches the development portion c, which corresponds in position to the development pole of the magnetic roller 4b, the developer layer is made to crest by the magnetic force. Thus, the electrostatic latent image on the peripheral surface of the photoconductive drum 2 is developed into a visible image, by the toner in the crest of the developer layer. Incidentally, in this embodiment, an electrostatic latent image is developed in reverse.

After being conveyed and passed through the development portion c, the thin layer of developer on the peripheral surface of the development sleeve 4a is made to enter the developer storage portion 4h, by the subsequent continual rotation of the development sleeve 4a. In the developer storage portion 4h, the developer layer is made to separate from the peripheral surface of the development sleeve 4a, by the repulsive magnetic field of the conveyance pole, and fall into the developer storage portion 4h. In other words, it is returned to the developer storage portion 4h.

To the development sleeve 4a, a combination of DC voltage and AC voltage is applied from an unshown electrical power source. In this embodiment, the combination of a DC voltage of 500 V and an AC voltage which is 2,000 Hz in frequency, and 1,500 V in peak-to-peak voltage, is applied to develop only the exposed points of the peripheral surface of the photoconductive drum 2.

Generally, in a two-component developing method, the application of AC voltage increases development efficiency, making it possible to form an image of higher quality. On the other hand, the application of AC voltage is likely to result in the formation of a foggy image. Therefore, it is a common practice to create a certain amount of difference in potential level between the potential level of the DC voltage applied to the development sleeve 4a and the potential level of the peripheral surface of the photoconductive drum 2 in order to prevent the formation of a foggy image. More specifically, bias voltage, the potential level of which falls between the potential level of an exposed point of the peripheral surface of the photoconductive drum 2, and the potential level of an unexposed point of the peripheral surface of the photoconductive drum 2, is applied.

As the toner is consumed by the development of an electrostatic latent image, the toner content of the developer decreases. In this embodiment, a sensor 4g for detecting the toner content is disposed in the adjacencies of the peripheral surface of a developer stirring screw 4cB, as shown in FIG. 2. As it is detected by the sensor 4g that the toner content of the developer has reduced below a predetermined level, a command for supplying the developer storage portion 4h of the developing apparatus 4 with the toner from the toner supply container 5 is issued to initiate a toner supplying operation, which maintains the toner content of the developer in the developing apparatus at a predetermined level.

### Toner Supply Container

The toner supply containers 5Y, 5M, 5C, and 5K are disposed in parallel above the process cartridges 1Y, 1M, 1C, and 1K, respectively, and are mounted into the image forming apparatus main assembly 100 from the front side of the apparatus main assembly 100.

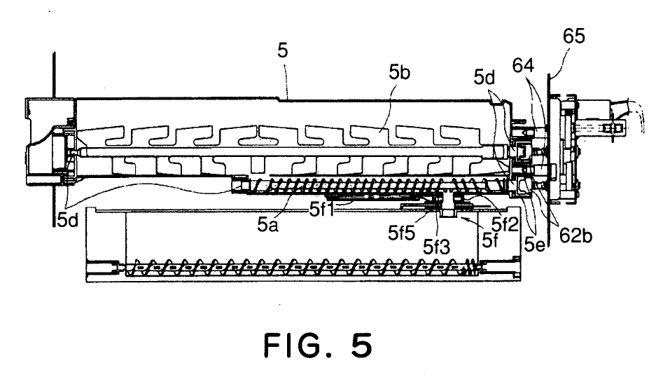

Referring to FIG. 2, the toner supply container 5 has a frame 5g as the toner storage portion (developer storage portion), in which toner, or a mixture of toner and magnetic carrier is stored. Within the frame 5g, a stirring plate 5b solidly fixed to a stirring shaft 5c, and a screw 5a (FIG. 5), are disposed.

The bottom wall of the toner supply container 5 is provided with a toner outlet 5f having a developer releasing hole through which the toner is discharged into a process cartridge 1.

Referring to FIG. 5, the screw 5a and stirring shaft 5c are rotatably supported by bearings 5d, by their lengthwise ends. The screw 5a is provided with a driving coupling (female coupling) 5e, which is attached to the back end (right end in FIG. 5) of the screw 5a, and the stirring shaft 5a is also provided with a driving coupling (female coupling) 5e, which is attached to the back end (right end in FIG. 5). The driving couplings (female couplings) 5e receive the driving force transmitted through the driving couplings (male couplings) 62d, one for one, of the image forming apparatus main assembly 100, being thereby rotationally driven. The screw 5a comprises two pieces of spiral ribs located on one side of the toner outlet 5f and the other, and twisted in the opposite direction. The screw 5a is rotated in the predetermined direction by the rotation of the driving coupling 62b. As a result, the toner is conveyed toward the toner outlet 5f, and free falls through the hole 5f5 of the toner outlet 5f into the process cartridge 1; in other words, the process cartridge 1 is supplied with the toner.

The peripheral edge, that is, the outermost edge of each section of the stirring plate 5b, in terms of the rotational radius of the developer sending member 5b, is angled relative to the stirring shaft 5c. Thus, as each section of the stirring plate 5b rubs against the internal surface of the toner supply container 5, its peripheral edge portion is angled at certain degrees relative to its base portion. More specifically, the peripheral edge portion of each section of the stirring plate 5b is spirally twisted. Thus, as the stirring shaft 5c is rotated, the toner in the toner supply container 5 comes into contact with the spirally twisted edge portions of the stirring plate 5c, being thereby conveyed in the lengthwise direction of the stirring shaft 5c.

Not only can the toner supply container 5 in this embodiment supply toner to a process cartridge, or a development cartridge, which employs a two-component developing method, but also to a process cartridge or a development cartridge, which employs a single-component developing method. Further, the powder to be stored in the toner supply container does not need to be limited to toner. For example, it may be the so-called developer, that is, a mixture of toner and magnetic carrier, which is needless to say.

### Transferring Means

The intermediary transfer unit 54, as a transferring means, in FIG. 1 is a unit for transferring all at once onto the recording medium 52 a plurality of toner images having been sequentially transferred in layers onto the intermediary transfer unit 54 from the photoconductive drum 2.

The intermediary transferring unit 54 is provided with an intermediary transfer belt 54a, which runs in the direction indicated by an arrow mark at virtually the same peripheral velocity as that of the photoconductive drum 2 which rotates in the clockwise direction indicated by another arrow mark. The intermediary transfer belt 54a is an endless belt with a circumferential length of approximately 940 mm, and is suspended around three rollers: a driver roller 54b, a belt backing transfer roller 54g which opposes the secondary transfer roller 54d, and a follower roller 54c.

Within the loop of the intermediary transfer belt 54a, transfer charge rollers 54fY, 54fM, 54fC, and 54fK are rotatably disposed, opposing the corresponding photoconductive drums 2 with the presence of the intermediary transfer belt 54a between the transfer charge rollers 54fY, 54fM, 54fC, and 54fK and the corresponding photoconductive drums 2. Each transfer charge roller is kept pressured toward the center of the corresponding photoconductive drum 2.

The transfer charge rollers 54fY, 54fM, 54fC, and 54fK are supplied with power by an unshown high voltage power source, and charge the intermediary transfer belt 54a to the polarity opposite to that of the toner, from the inward side of the loop of the intermediary transfer belt 54a, in order to sequentially transfer the toner images on the photoconductive drum 2 onto the outward surface of the intermediary transfer belt 54a.

During transfer, the secondary transfer roller 54d as a transferring member is kept pressed on the intermediary transfer belt 54a, opposing the belt backing transfer roller 54g with the presence of the intermediary transfer belt 54a between the secondary transfer roller 54d and belt backing transfer roller 54g. The secondary transfer roller 54d is movable in the vertical direction in FIG. 1, and is rotatable. Until a predetermined number of images are sequentially transferred in layers onto the intermediary transfer belt 54a to complete a multicolor image, the secondary transfer roller 54d is kept apart from the intermediary transfer belt 54a in order not to disturb the images on the intermediary transfer belt 54a.

The intermediary transfer belt 54a and secondary transfer roller 54d are individually driven. As the recording medium 52 is entered into the secondary transfer portion, a predetermined bias is applied to the secondary transfer roller 54d. As a result, the toner images on the intermediary transfer belt 54a are transferred (secondary transfer) onto the recording medium 52.

During the transfer process, the recording medium 52 is conveyed leftward of FIG. 1 at a predetermined velocity, while remaining sandwiched between the secondary transfer roller 54d and intermediary transfer belt 54a, to a fixing device 56 which carries out the next process.

The image forming apparatus main assembly 100 is provided with a cleaning unit 55, which can be placed in contact with, or moved away from, the surface of the intermediary transfer belt 54a, and which is at a predetermined location in the adjacencies of the downstream end of the intermediary transfer belt 54a in terms of the direction in which the recording medium is conveyed during the transfer process. The cleaning unit 55 removes the secondary transfer residual toner, that is, the toner remaining on the intermediary transfer belt 54a after the secondary transfer.

Referring again to FIG. 1, within the cleaning unit 55, a cleaning blade 55a for removing the transfer residual toner is disposed. The cleaning unit 55 is attached to the main assembly 100 of the image forming apparatus so that it can be pivoted about an unshown pivotal axis. The cleaning blade 55a is kept pressed on the intermediary transfer belt 54a, being tilted so that the cleaning edge of the cleaning blade 55a is on the upstream side relative to the base portion of the cleaning blade 55a in terms of the moving direction of the intermediary transfer belt 54a. After being taken into the cleaning unit 55, the transfer residual toner is conveyed by a screw 55b to a removed toner bin (unshown) and is stored therein.

### Fixing Portion

As described above, a toner image formed on the photoconductive drum 2 by the developing means is transferred onto the recording medium 52 by way of intermediary transfer belt 54a. Then, the fixing device 56 thermally fixes the unfixed toner images, that is, the images having just been transferred onto the recording medium 52, to the recording medium 52.

Also referring to FIG. 1, the fixing device 56 is provided with a fixing roller 56a for applying heat to the recording medium 52, and a pressure roller 56b for pressing the recording medium 52 against the fixing roller 56a. Both rollers 56a and 56b are hollow. Each roller contains a heater (unshown) in its hollow. They together convey the recording medium 52 as they are rotationally driven.

In other words, while the recording medium 52, which is bearing toner images, is conveyed by the fixing roller 56a and pressure roller 56b, heat and pressure are applied to the recording medium 52 and toner images by the rollers. As a result, the toner images are fixed to the recording medium 52. After the fixation, recording medium 52 is discharged out of the image forming apparatus main assembly 100 by two pairs 53h and 53j of discharge rollers, into a delivery tray 57 on top of the image forming apparatus main assembly 100, and is accumulated therein.

### Mounting of Process Cartridge and Toner Supply Container

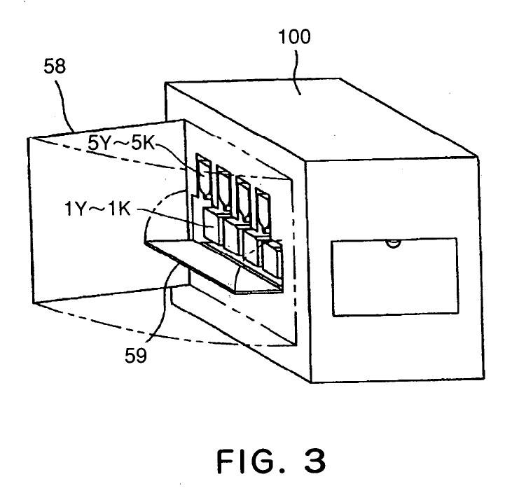

Next, referring to FIGS. 2-5, the procedure for mounting the process cartridge 1 and toner supply container 5 into the image forming apparatus main assembly 100 will be described. Referring to FIG. 3, which is a schematic external perspective view of the image forming apparatus main assembly 100, the image forming apparatus main assembly 100 is provided with a front door 58, which is located in the front panel of the image forming apparatus main assembly 100 and can be freely opened or closed. As an operator opens the front door 27 frontward, the openings through which the process cartridges 1Y-1K, and toner supply containers 5Y-5K, are inserted, are exposed.

The openings through which the process cartridge 1 is inserted are provided with the drum shaft positioning plate 59, which is rotatably supported. Thus, when inserting or removing the process cartridge 1, this drum shaft positioning plate 59 must be opened. Referring to FIG. 2, in the image forming apparatus main assembly 100, four pairs of guiding rails 60 for guiding the process cartridge 1 when mounting the process cartridge 1, and four pair of guiding rails 61 for guiding the toner supply container 5 when mounting the toner supply container 5, are provided.

The directions in which the process cartridge 1 and toner supply container 5 are mounted into the image forming apparatus main assembly 100 are parallel to the axial line of the photoconductive drum 2, and so are the directions in which the guiding rails 60 and 61 extend. The process cartridge 1 and toner supply container 5 are inserted into the image forming apparatus main assembly 100, from the front side of the image forming apparatus main assembly 100, and then, are slid deeper into the image forming apparatus main assembly 100 along the guiding rails 60 and 61.

Referring to FIG. 4, as the process cartridge 1 reaches the deepest end of the image forming apparatus main assembly 100, the drum positioning shaft 66 of the image forming apparatus main assembly 100 enters the center hole 2f of the drum flange 2b. As a result, the rotational axis of the back end of the photoconductive drum 2 is accurately positioned relative to the image forming apparatus main assembly 100.

At the same time, the driving force transmitting portion 2g of the drum flange 2b engages with the driving coupling (female coupling) 62a of the image forming apparatus main assembly 100, making it possible for the photoconductive drum 2 to be rotationally driven. The driving force transmitting portion 2g in this embodiment is in the form of a twisted triangular column. Thus, as driving force is transmitted to the driving force transmitting portion 2g from the image forming apparatus main assembly 100, not only does the driving force transmitting portion 2g transmit the driving force to the photoconductive drum 2, but also generates such force that pulls the photoconductive drum 2 toward the back end of the image forming apparatus main assembly 100.

Also referring to FIG. 4, the rear wall 65 of the image forming apparatus main assembly 100 is provided with four cartridge supporting pins 63 for accurately positioning the process cartridges 1, one for one. Each cartridge supporting pin 63 enters the frame 1a of the inserted process cartridge 1, whereby the frame 1a of the process cartridge 1 is accurately fixed in its position relative to the image forming apparatus main assembly 100.

Referring again to FIG. 4, on the front side (left side in FIG. 4) of the image forming apparatus main assembly 100, the drum shaft positioning plate 59, which is rotationally opened or closed, is disposed, and with which the bearing case 2c of the process cartridge 1 is solidly engaged. Through the above described process cartridge insertion sequence, the photoconductive drum 2 and process cartridge 1 are accurately positioned relative to the image forming apparatus main assembly 100.

In comparison, referring to FIG. 5, as the toner supply container 5 is inserted to the deepest end, it is solidly held by the supporting pin 64 projecting from the rear wall 65 of the image forming apparatus main assembly 100 as is the process cartridge 1 by the supporting pin 64. At the same time, the driving coupling (female) 5e engages with the driving coupling (male) 62b, making it possible to rotationally drive the screw 5a and stirring shaft 5c.

When the toner supply container 5 is mounted into the apparatus main assembly 100 in which the process cartridge is present, or when the process cartridge 1 is mounted into the apparatus main assembly 100 in which the toner supply container 5 is present, they are connected to each other by the connective portion, that is, the bottom end portion of the retaining member 5f2 of the toner supply container 5f2, at the completion of the mounting of the toner supply container 5 or the process cartridge. As a result, the toner discharged through the outlet 5f of the toner supply container 5 is supplied to the process cartridge 1.

All that is necessary to extract the process cartridge 1 or toner supply container 5 from the image forming apparatus main assembly 100 is to carry out the above described procedures in reverse.

In this embodiment, the process cartridge 1 and toner supply container 5 can be mounted into, or removed from, the image forming apparatus main assembly 100 in random order. In other words, it is possible to mount the toner supply container 5 into the image forming apparatus main assembly 100 after mounting the process cartridge 1 into the image forming apparatus main assembly 100, or to mount the process cartridge 1 into the image forming apparatus main assembly 100 after mounting the toner supply container 5 into the image forming apparatus main assembly 100. Further, it is possible to extract the toner supply container 5 from the image forming apparatus main assembly 100 after extracting the process cartridge 1 from the image forming apparatus main assembly 100, or to extract the process cartridge 1 from the image forming apparatus main assembly 100 after extracting the toner supply container 5 from the image forming apparatus main assembly 100.

### EMBODIMENT 1

Next, the toner supply container in the form of a cartridge, in the first embodiment of the present invention will be described in more detail.

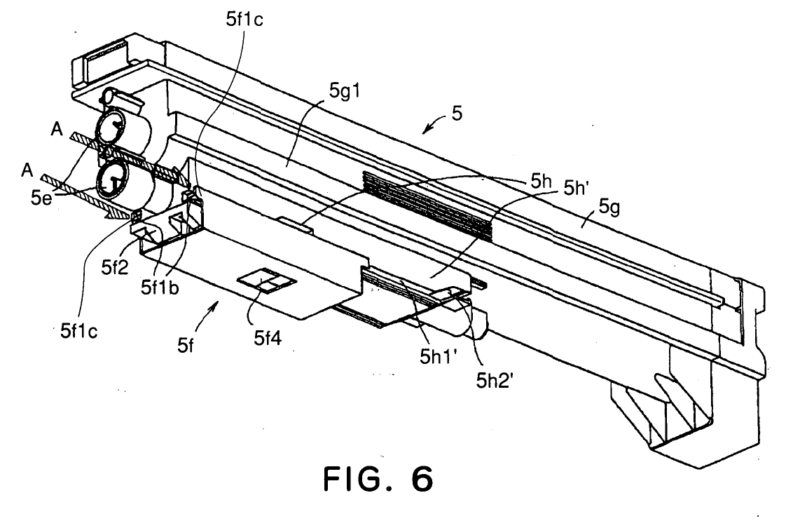

FIG. 6 is a perspective view of the toner supply container 5 in this embodiment of the present invention, as seen from below the back end thereof.

As shown in FIG. 6, the toner supply container 5 is provided with a pair of guiding portions 5g1, which are on the lengthwise lateral walls, one for one, of the frame 5g of the toner supply container 5, and which function as guides when the toner supply container 5 is inserted into the image forming apparatus main assembly 100. The toner supply container is also provided with a toner outlet 5f, which is attached to the bottom wall of the toner supply container 5, and a toner outlet cover 5f1 for covering the toner outlet 5f. The outlet cover 5f1 is provided with a pair of latching portions 5f1a and a pair of latching portions 5f1b, which engage with the pair of rails 5h of the toner supply container 5, allowing thereby the outlet cover 5f1 to move along the pair of rails 5h.

Prior to the mounting of the toner supply container 5 into the apparatus main assembly 100, the outlet cover 5f is in the first position in which it covers the outlet 5f.

When the toner supply container 5 is inserted into the apparatus main assembly 100, the guiding portions 5g1 slide on the guide rails 61 of the apparatus main assembly 100, one for one, and as the toner supply container 5 is inserted, the outlet cover 5f1 comes into contact with a pair of projections 68 located in the adjacencies of the corresponding guide rails 61.

As the toner supply container 5 is further inserted from the point of contact, the outlet cover 5f1 is prevented by the projection 68 from moving forward, being pushed, in relative terms, by the projection 68. As a result, the outlet cover 5f1 horizontally moves relative to the main assembly of the toner supply container 5 along the rails 5h, until it reaches the second position in which it exposes the retaining member 5f2 as the connective portion between the outlet 5f of the toner supply container 5 and process cartridge. The portion of the outlet cover 5f1, by which the outlet cover 5f1 is pushed by the projection 68 is the contact portion 5f1c of the outlet cover 5f1; the toner outlet cover 5f1 is pushed, in relative terms, by the projection 68 in the direction indicated by an arrow marks in FIG. 6.

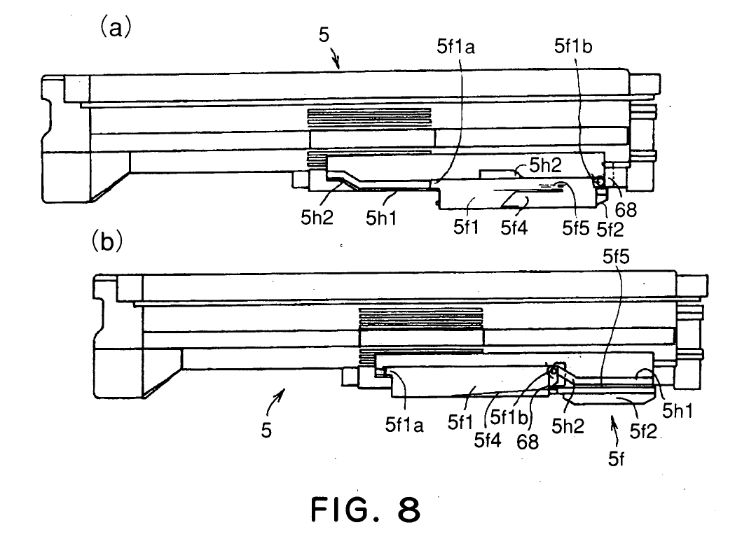

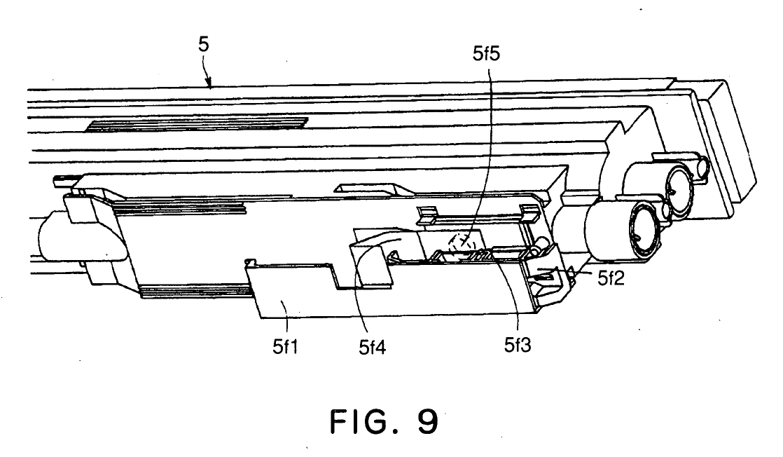

FIG. 8 is a drawing for describing in detail the movement of the outlet cover 5f1. In this drawing, the position of outlet cover 5f1 at the beginning of the mounting of the toner supply container 5 into the apparatus main assembly 100, and the position of the outlet cover 5f1 at the end thereof, are shown by the top and bottom sides, respectively, of the drawings. FIG. 9 is an enlarged view of the outlet portion 5f at the beginning of the mounting. In the drawing, the right halves of the toner outlet cover 5f1, retaining member 5f2, and toner outlet shutter 5f3, as seen from the trailing side thereof, in terms of the toner supply cartridge insertion direction, have been removed for the ease of visual confirmation.

Referring to FIG. 9, the hole 5f5 of the toner outlet 5f is sealed with the tape 5f4, which is folded back at a point in the adjacencies of the hole 5f5, is doubled back past the hole 5f5, and is fixed to the outlet cover 5f1.

Referring to FIG. 8, prior to the beginning of the mounting of the toner supply container 5 into the apparatus main assembly 100, the hole 5f5 has been sealed with the tape 5f4. However, as the toner supply container 5 is inserted into the apparatus main assembly 100, the outlet cover 5f1 is moved relative to the main assembly of the toner supply container 5, while dragging the tape 5f4 fixed to the outlet cover 5f1 by one end. Therefore, by the time the mounting of the toner supply container 5 into the apparatus main assembly 100 ends, the hole 5f5 will have been completely exposed.

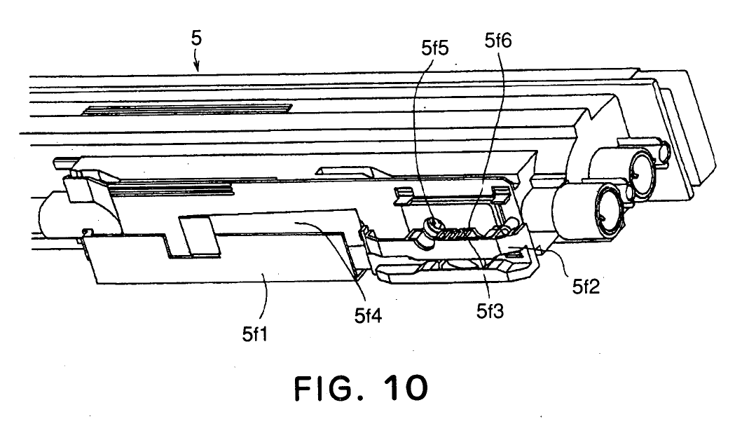

FIG. 10 is an enlarged view of the toner outlet 5f at the end of the mounting of the toner supply container 5 into the apparatus main assembly 100. Also in this drawing, the right halves of the toner outlet cover 5f1, retaining member 5f2, and toner outlet shutter 5f3, as seen from the trailing side thereof, in terms of the toner supply cartridge insertion direction, have been removed for the ease of visual confirmation.

It must be assured that the outlet cover 5f1 will not dislodge during the period from the completion of the manufacture of the toner supply container 5 until a user actually mounts the toner supply container 5 into the apparatus main assembly 100. However, the toner supply container 5 is subjected to various shocks during the period from the completion of the manufacture of the toner supply container 5 until a user uses the toner supply container 5 for the very first time, during the shipment of the toner supply container 5, or during the like period. Thus, there is a concern that unless the outlet cover 5f1 is secured with some kind of means so that it will not easily move, the tape 5f4 will be peeled by the movement of the outlet cover 5f1, allowing thereby the developer from leaking.

Thus, in this embodiment, the toner supply container 5 is structured so that until it is mounted into the apparatus main assembly 100, the outlet cover 5f1 will not easily move.

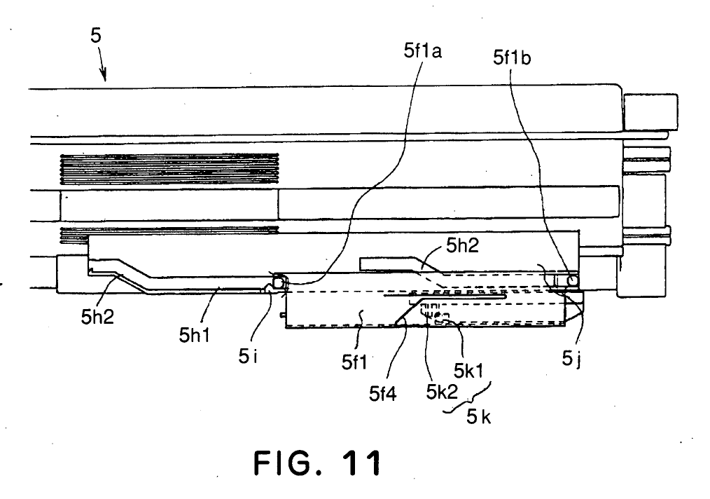

FIG. 11 is an enlarged side view of the toner outlet cover 5f1, and its adjacencies, of the toner supply container 5, as seen from the direction perpendicular to the lengthwise direction of the toner supply container 5.

As will be evident from the drawing, the outlet cover 5f1 is locked in place by latch portions 5i, 5j, and 5k.

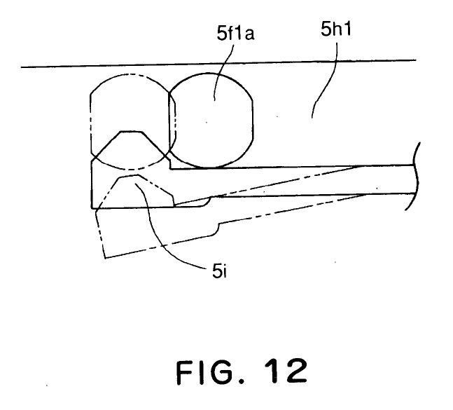

Next, referring to FIG. 12-14, the latch portions 5i, 5j, and 5k will be described.

FIG. 12 is an enlarged view of the first latch portion 5i of the outlet cover retaining means, and the corresponding catch portion 5f1a of the section 5f1 of the rail 5h.

As will be evident from the drawing, the firs latch portion 5i engages with the catch portion 5f1a of the section 5h1 of the rail 5h.

In this embodiment, the frame 5g is molded of resin, and the first latch portion 5i is an integral part of the frame 5g. Thus, the first latch portion 5i is allowed to elastically flex as contoured by the double-dot chain line in the drawing.

Referring to FIG. 12, the front and back surface of the head portion of the first latch portion 5i, in terms of the toner supply container insertion direction, are angled rearward and frontward, respectively, making the head portion tapered. Therefore, when the toner supply container 5 is inserted or extracted, the first latch portion 5f1a of the outlet cover 5f1 comes into contact with the front or back surface of the catch portion 5f1a of the section 5h1 of the rail 5h, causing thereby the first latch portion 5i to elastically flex to allow the latch portion 5i to ride over the catch portion 5f1a.

Obviously, a certain amount of force is necessary to elastically flex the first latch portion 5i of the toner supply container 5, as contoured by the double-dot chain line, to allow the first latch portion 5i to ride over the catch portion 5f1a. This force necessary to elastically flex the first latch portion 5i equals the latent force F1 which keeps the outlet cover 5f1 retained in place at the catch portion 5f1a. In other words, the latent force F1 capable of retaining the outlet cover 5f1 in place equals the amount of the resiliency of the flexible latch portion 5i.

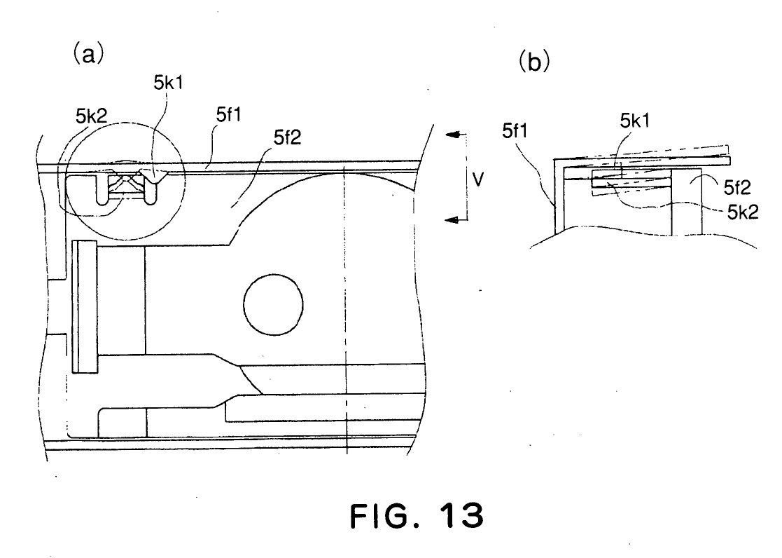

FIG. 13 is an enlarged view of the second portion 5k of the toner supply container 5, for retaining the outlet cover 5f1 in place. In the drawing, the top half is a plan view as seen from above, and the bottom half is a side view as seen from the direction perpendicular to the lengthwise direction of the toner supply container 5.

As is evident from the drawing, the latch portion 5k1 of the outlet cover 5f1 is engaged with the catch portion 5k2 of the connective portion of the retaining member 5f2, and the outlet cover 5f1 is in the first position.

The outlet cover 5f1 and the connective portion of the retaining member 5f2 are molded of resin, and the latch portion 5k1 and catch portion 5k2 thereof, respectively, are structured so that they are allowed to elastically flex.

Both the latch portion 5k1 and catch portion 5k2 are tapered so that they reduce in width toward their tips; their front and back surfaces, in terms of the toner supply container insertion direction, are slanted backward and frontward, respectively. Therefore, whether it is when the toner supply container 5 is inserted into, or extracted from, the apparatus main assembly 100, the latch portion 5k1 and catch portion 5k2 both elastically flex.

With the provision of this structural arrangement, the latch proper 5k1 of the second toner supply container retaining portion 5k is kept engaged with the catch portion 5k2 of the second toner supply container retaining portion 5k, by a force F2, which equals the reactive force which the combination of the latch proper 5k1 and catch portion 5k2 are capable of generating by their elasticity.

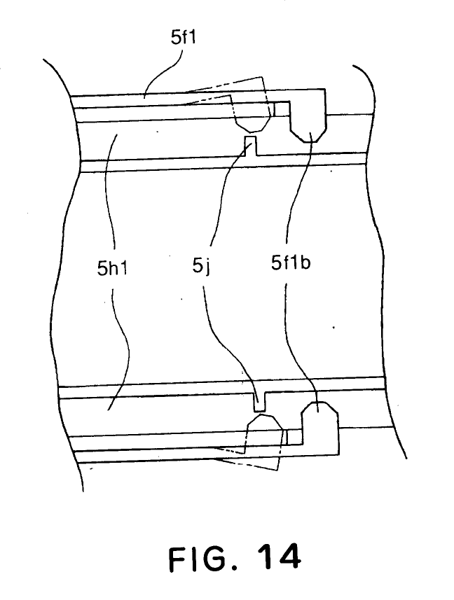

FIG. 14 is an enlarged view of the third portion 5j of the toner supply container 5, for retaining the outlet cover 5f1 in place.

As is evident from the drawing, as the movement of the outlet cover 5f1 relative to the main assembly of the toner supply container 5 in terms of the lengthwise direction of the toner supply container 5 is checked by the contact between the latch portion 5f1b of the outlet cover 5f1 engaged with the section 5h1 of the rail 5h, and the catch portion 5j of the third portion for retaining the outlet cover 5f1 in place. The front and back sides of the end portion of the latch portion 5f1b of the outlet cover 5f1, in terms of the toner supply container insertion direction, are slanted backward and forward, respectively. Therefore, whether it is when the toner supply container 5 is inserted into, or extracted from, the apparatus main assembly 100, these slanted surfaces come into contact with the catch portion 5j of the third portion for retaining the outlet cover 5f1 in place, causing the latch portion 5f1b to elastically flex.

As will be evident from the above description, a latent force F3 which keeps the outlet cover 5f1 virtually locked in place comes from the elasticity of the elastically flexible latch portion 5f1b.

In other words, as the means for checking the movement of the outlet cover 5f1 in the toner supply container insertion direction, one or both of the outlet cover 5f1 and the main assembly of the toner supply container 5 are provided with an elastically flexible hook, latch, catch, or the like, so that the movement of the outlet cover 5f1 is checked by the contact between the elastically flexible portions of the outlet cover 5f1 and the elastically flexible portions of the main assembly of the toner supply container 5.

The weight of the outlet cover 5f1 in this embodiment is approximately 15 g-20 g. According to the studies made by the inventors of the present invention, the amount of the impact F₀ to which the outlet cover 5f1 is subjected during shipment is roughly 24.5 N.

Therefore, it is reasonable to think that as long as the total latent (reactive) force F which can be generated by the elasticity of the toner outlet cover retaining (securing) means in this embodiment is greater than 24.5N, in other words, as long as F=F1+F2+F3>24.5 N, the shocks to which the outlet cover 5f1 is subjected do not move the outlet cover 5f1 from the first position to the second position. It should be noted here that the latent force F is the amount of force necessary to be applied to the contact portion 5f1c of the outlet cover 5f1 in the direction indicated by an arrow mark A, in order to move the outlet cover 5f1 from the first position to the second position.

It has been known through the studies made by the inventors of the present invention that as long as the latent force F (which hereinafter will be referred to as retentive force F) satisfies the following inequity: F<68.6 N, there is no problem as far as the operability of the toner supply container 5 is concerned.

Therefore, all that is necessary is for the retentive force F to satisfy the following inequity: 24.5 N<F<68.6 N. In this embodiment, the toner supply container 5 is designed so that the total of the retentive forces from the latch portions 5i, 5j, and 5k falls within a range of 29.4 N-58.8 N.

Incidentally, in this embodiment, the means for retaining the outlet cover in place (which hereinafter will be referred to as retentive means) is made up of a plurality of portions for retaining the outlet cover in place (which hereinafter will be referred to as retentive portions). However, the retentive means may be made up of a single retentive portion as long as it satisfies the above described requirements regarding the correlation between the amount of the shock and the amount of the retentive force, and the correlation between the amount of retentive force and the operability of the toner supply container 5.

The reason why the retentive means in this embodiment is made up of the plurality of retentive portions is as follows:

First, it is for reducing the size of the retentive means by replacing a single large retentive portion with a plurality of small retentive portions, because it is possible to provide a greater amount of retentive force by the employment of a plurality of small retentive portion, instead of a single large retentive portion. In other words, it is possible to provide the force necessary for outlet cover retention, without relying on a single large retentive portion.

Another reason is the so-called malfunction countermeasure. In other words, with the provision of the plurality of retentive portions, even if one of the retentive portions fails, the rest of the retentive portions make it possible for the toner supply container 5 to withstand a certain amount of shock.

As described above, the toner supply container 5 in this embodiment is provided with three retentive portions different in location, on each side. More specifically, three retentive portions (latch portions and catch portions) 5i, 5j, and 5k are disposed, on each side, on the hypothetical lines extended approximately in the direction indicated by arrow marks A in FIG. 6 from the points by which the outlet cover 5f1 is pushed by the projections 68.

With the above described placement of the retentive portions, the outlet cover 5f1 can be freed and slid without chattering.

More specifically, as the outlet cover 5f1 is pushed by the contact points 5f1c, reactive force is generated at each of the retentive portions. Thus, it is reasonable to think that as long as the requirements for preventing the sum of the reactive forces generated at the retentive portions, from generating moment in the outlet cover 5f1, is satisfied, the outlet cover 5f1 will not chatter or rattle. In this embodiment, the toner supply container 5 is structured so that all of these requirements are satisfied for all practical purposes.

This embodiment of the present invention relates to the means for retaining in place the covering member of a toner supply containers. However, the above described structural arrangement for a toner supply container is also applicable to a process cartridge, which is obvious.

### EMBODIMENT 2

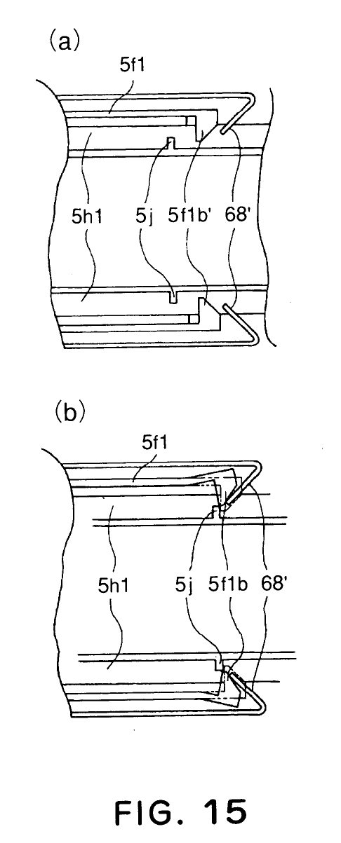

Shown in FIG. 15 is the second embodiment of the present invention. In this embodiment, the main assembly of an image forming apparatus is provided with a means for disengaging the outlet cover retaining means. More specifically, the toner supply container in this embodiment is structured so that the latch portion 5f1b′ of the outlet cover 5f1 is disengaged from the third catch portion 5j by a disengaging means on the apparatus main assembly side.

Otherwise, the toner supply container in this embodiment is structured as is the toner supply container in the first embodiment. Thus, the structural arrangement other than the means for disengaging the latch portion 5f1b′ from the third catch portion 5j will not be described.

FIG. 15 is an enlarged view of the outlet cover retaining means, and its adjacencies, in the second embodiment of the present invention.

This drawing shows the movements of the outlet cover 5f1 and the retentive portion therefor, which occur with the progression of the insertion of the toner supply container 5 into the apparatus main assembly 100. With the progression of the insertion, the states of the outlet cover 5f1 and the retentive portion therefor change from the state shown in FIG. 15(a) to that in FIG. 15(b).

This embodiment is different from the above described first embodiment in that in this embodiment, the head portion of the latch portion 5f1b′ of the outlet cover 5f1 is given a slanted surface only on one side (side toward which toner supply container 5 is extracted from apparatus main assembly).

The opposing side of the latch portion 5f1b′ is given a surface perpendicular to the direction in which the toner supply container 5 is inserted into the apparatus main assembly. In addition, the surface of the third catch portion 5j, with which the latch portion 5f1b′ engages, is made perpendicular to the toner supply container insertion direction.

Therefore, as far as the relationship between the latch portion 5f1b′ and third latch portion 5j is concerned, once the latch portion 5f1b′ engages with third latch portion 5j, the application of additional force does not result in the bending of the latch portion 5f1b′, because the engagement between the latch portion 5f1b′ and third latch portion 5j occurs by their surfaces perpendicular to the toner supply container insertion direction. In other words, the application of the additional force does not result in the disengagement between the latch portion 5f1b′ and third latch portion 5j. Of course, application of an extremely large force will result in the destruction of one of the two retentive portions, which results in the disengagement. In this embodiment, however, such an extraordinary situation has not been taken into consideration.

Also in this embodiment, the projection 68′ of the apparatus main assembly is tilted at an angle which matches the angle of the slanted surface of the latch portion 5f1b′.

With the provision of this structural arrangement, as the toner supply container 5 is inserted into the apparatus main assembly, the slanted surface of the latch portion 5f1b′ comes into contact with the slanted surface of the projection 68′. Then, as the toner supply container 5 is inserted deeper, the latch portion 5f1b′ moves with the outlet cover 5f1, and comes into contact with the third latch portion 5j.

Then, as the toner supply container 5 is inserted more deeply, the latch portion 5f1b′ slides onto the projection 68′, with the slanted surface of the latch portion 5f1b′ remaining in contact with the slanted surface of the projection 68′. As a result, the latch portion 5f1b′ is bent in the direction to move away from the third catch portion 5j as shown in FIG. 15(b), being thereby allowed to move over the third catch portion 5j; in other words, the outlet cover 5f1 is released. As is evident from the above description, not only does the projection 68′ in this embodiment have the function of pushing the outlet cover 5f1, but also it plays the role of an outlet cover releasing means which disengages the latch portion 5f1b′ from the catch portion 5j.

As described above, in this embodiment, the outlet cover 5f1 is not released from its first position unless it is released from the first position by the projection 68′, as the outlet cover releasing means, of the apparatus main assembly. With the employment of this structural arrangement, not only is it possible to prevent the sealing tape 5f4 from being accidentally peeled by the shocks or the like which occur during shipment, but also it is possible to prevent the sealing tape 5f4 from being accidentally peeled while the toner supply container 5 is assembled or packaged.

Next, the above descriptions of the embodiments of the present invention will be summarized, and also, will be supplemented as necessary.

The toner supply container 5, in the form of a cartridge, in accordance with the present invention, which comprises:

the frame 5g as a developer storage portion for holding developer (toner, or mixture of toner and magnetic carrier);

the outlet 5f5 as a portion through which the developer in the frame 5g is discharged; and

the piece of tape 5f4 as a sealing member which is for keeping the outlet 5f5 sealed until the toner supply container 5 is used for the very first time, and is peelable to expose the hole of the outlet 5f5 when the toner supply container 5 is used for the first time; and

which is removably mountable in the main assembly of an image forming apparatus;

is characterized in that the toner supply container 5 further comprises:

the outlet cover 5f1 as a cartridge cover, to which one end of the tape 5f4 is fixed, so that, as the outlet cover 5f1 is moved from the position in which it covers the hole of the outlet 5f5 to the position in which it exposes the hole of the outlet 5f5, by the mounting of the toner supply container 5 into the image forming apparatus main assembly, the outlet cover 5f1 peels the tape 5f4; and

the outlet cover retaining means (retentive portions 5k, 5j, and 5k) for retaining the outlet cover 5f1 in the position (first position) in which the outlet cover 5f1 covers the hole of the outlet 5f5.

With the provision of the above described structural arrangement, the tape 5f4 can be peeled by the operation for mounting the toner supply container 5 into the image forming apparatus main assembly. In other words, the mounting of the toner supply container 5 and peeling of the tape 5f4 can be accomplished by a single operation, improving thereby operational efficiency, and also, preventing the problem that a user mounts the toner supply container 5 into the image forming apparatus main assembly without remembering to peel the tape 5f4.

Further, with the provision of the outlet cover retaining means, it is possible to prevent the outlet cover 5f1 from easily dislodging. Therefore, it is possible to prevent the tape 5f4 from being peeled before the toner supply container 5 is used for the very first time. Therefore, it is possible to prevent the developer in the toner supply container 5 from leaking before the toner supply container 5 is used for the very first time.

The outlet cover retaining means is desired to be an elastic outlet cover retaining means which utilizes its elasticity to retain the outlet cover 5f1 in place.

The outlet cover retaining means is desired to have a plurality of retentive portions different in location.

With this configuration, not only is it possible to reduce in size the structural components of the outlet cover retaining means, but also, a certain amount of retentive force (capacity) remains, even if one of the retentive portions happens to break.

The retentive force by the outlet retaining means is desired to be in the range of 29.4 N-58.8 N.

With the retentive force being in the above described range, it is possible to easily satisfy the requirement that the retentive force is desired to be no less than the theoretical shock of 24.5 N to which the toner supply container 5 might be subjected during shipment or the like, and the requirement that, for the sake of operability, the retentive force is desired to be no more than 68.6 N.

Further, the image forming apparatuses in the preceding embodiments of the present invention, in which the toner supply container 5, in the form of a cartridge, is removably mountable, and which is for forming an image on recording medium (paper or the like), is characterized in that it comprises:

the mounting mechanism (essentially, guide rails 61) for removably mounting the toner supply container 5 removably mountable in the main assembly of an image forming apparatus and comprising: the frame 5g as a developer storage portion for holding developer (toner, or mixture of toner and magnetic carrier); the outlet 5f5 as a portion through which the developer in the frame 5g is discharged; the piece of tape 5f4 as a sealing member which is for keeping the outlet 5f5 sealed until the toner supply container 5 is used for the very first time, and is peelable to expose the hole of the outlet 5f5 when the toner supply container 5 is used for the first time; and the outlet cover 5f1 as a cartridge cover, to which one end of the tape 5f4 is fixed, so that, as the outlet cover 5f1 is moved from the position, in which it covers the hole of the outlet 5f5, to the position in which it exposes the hole of the outlet 5f5, by the mounting of the toner supply container 5 into the image forming apparatus main assembly, it peels the tape 5f4; and

the outlet cover retaining means (retentive portions 5k, 5j, and 5k) for retaining the outlet cover 5f1 in the position (first position) in which the outlet cover 5f1 covers the hole of the outlet 5f5.

With the provision of this structural arrangement, the tape 5f4 can be peeled by the operation for mounting the toner supply container 5 into the image forming apparatus main assembly. In other words, the mounting of the toner supply container 5 and peeling of the tape 5f4 can be accomplished by a single operation, improving thereby operational efficiency, and also, preventing the problem that a user mounts the toner supply container 5 into the image forming apparatus main assembly without remembering to peel the tape 5f4.

Further, with the provision of the outlet cover retaining means, it is possible to prevent the outlet cover 5f1 from easily dislodging. Therefore, it is possible to prevent the tape 5f4 from being peeled before the toner supply container 5 is used for the very first time. Therefore, it is possible to prevent the developer in the toner supply container 5 from leaking before the toner supply container 5 is used for the very first time.

It is desired that the image forming apparatus main assembly is provided with the projection 68′ as an outlet cover releasing means, which is made to disengage the outlet cover retaining means, by the operation for mounting the toner supply container 5 into the image forming apparatus main assembly.

With the provision of this structural arrangement, not only is it possible to prevent the sealing tape from being accidentally peeled by the shocks or the like which occur during shipment, but also it is possible to prevent the sealing tape from being accidentally peeled while the toner supply container 5 is assembled or packaged.

As described above, with the provision of the structural arrangements in the preceding embodiments of the present invention, it is possible to simplify the operation for peeling the sealing tape when a cartridge is used for the very first time, while preventing the sealing tape from being easily peeled before the cartridge is used for the very first time.

As will be evident from the above descriptions of the embodiments of the present invention, the present invention makes it easy to remove the sealing tape from a cartridge before the cartridge is used for the very first time. It also prevents the sealing tape from being easily removed from a cartridge before the cartridge is mounted into the main assembly of an electrophotographic image forming apparatus for the very first time. Therefore it prevents the developer in the cartridge from leaking before the cartridge is mounted into the apparatus main assembly for the very first time. Further, it makes it possible to reduce in size an electrophotographic image forming apparatus in which the above described cartridge is removably mountable.

While the invention has been described with reference to the structures disclosed herein, it is not confined to the details set forth, and this application is intended to cover such modifications or changes as may come within the purposes of the improvements or the scope of the following claims.

What is claimed is:

1. A cartridge detachably mountable to a main assembly of an electrophotographic image forming apparatus, said cartridge comprising:
a developer accommodating portion for accommodating a developer;
a developer supply port for supplying the developer to developing means for developing an electrostatic latent image formed on an electrophotographic photosensitive member;
a removable sealing tape for sealing said developer supply port;
a covering member which is capable of taking an opening position f or opening said developer supply port and a closing position for closing said developer supply port and to which one longitudinal end of said sealing tape is fixed, said covering member is effective to cover said sealing tape sealing said developer supply port when it is at the closing position;
a cartridge locking portion for locking said covering member at the closing position;
wherein when said cartridge is mounted to the main assembly of the apparatus, locking between said cartridge locking portion and said covering member is released by engagement between said covering member and the main assembly of the apparatus, and said covering member moves from said closing position to said opening position, and said sealing tape is removed from said developer supply port to open said developer supply port.

2. A cartridge according to claim 1, wherein said covering member includes a cover side locking portion for locking with said cartridge locking portion.

3. A cartridge according to claim 2, wherein said cover side locking portion is locked with a guide portion provided in said cartridge to guide movement of said covering member between the closing position and t opening position.

4. A cartridge according to claim 1, wherein said cartridge locking portion includes,
a first inclined surface inclined in a direction of permitting movement of said covering member from t closing position to the opening position, said first inclined surface being effective to release locking between said cartridge locking portion and when covering member moves from t closing position to the opening position; and
a second inclined surface inclined in a direction of permitting movement of said covering member from the opening position to the closing position, said second inclined surface is effective to release locking between said cartridge locking portion and said covering member when said covering member moves from t opening position to the closing position.

5. A cartridge according to claim 2, wherein said cover side locking portion includes,
a first inclined surface inclined in a direction of permitting movement of said covering member from the closing position to the opening position, said first inclined surface is effective to release locking between said cartridge locking portion and said cover side locking portion when said covering member moves from the closing position to the opening position
a second inclined surface inclined in a direction of permitting movement of said covering member from the opening position to the closing position, said second inclined surface is effective to release locking between said cartridge locking portion and said cover side locking portion when said covering member moves from the opening position to the closing position.

6. A cartridge according to claim 1, wherein said covering member includes a portion to be urged by a projection provided in t main assembly of the apparatus when said cartridge is mounted to the main assembly of the apparatus.

7. A cartridge according to claim 6, wherein said cartridge locking portion is disposed substantially on an extension line extending in a direction of urging of the portion to be urged by said projection.

8. A cartridge according to claim 1, wherein locking between said cartridge locking portion and said covering member is released by elastic deformation of said covering member when locking between said cartridge locking portion and said covering member is released.

9. A cartridge according to claim 1, wherein locking between said cartridge locking portion and said covering member is released by elastic deformation of said cartridge locking portion when locking between said cartridge locking portion and said covering member is released.

10. A cartridge according to claim 1, wherein said cartridge locking portion is provided at each of a plurality of positions.

11. A cartridge according to claim 1, wherein a force applied to said covering member to release locking between said cartridge locking portion and said covering member is 29.4N-58.8N.

12. An electrophotographic image forming apparatus for forming an image on a recording material, to which a cartridge is detachably mountable, said apparatus comprising:
(i) mounting means for detachably mounting a cartridge, which includes a developer accommodating portion for accommodating a developer; a developer supply port for supplying the developer to developing means for developing an electrostatic latent image formed on an electrophotographic photosensitive member; a removable sealing tape for sealing said developer supply port; a covering member which is capable of taking an opening position f or opening said developer supply port and a closing position for closing said developer supply port and to which one longitudinal end of said sealing tape is fixed, said covering member is effective to cover said sealing tape sealing said developer supply port when it is at the closing position; a cartridge locking portion for locking said covering member at the closing position;
(ii) feeding means for feeding the recording material,
wherein when said cartridge is mounted to the main assembly of the apparatus, locking between said cartridge locking portion and said covering member is released by engagement between said covering member and the main assembly of the apparatus, and said covering member moves from said closing position to said opening position, and said sealing tape is removed from said developer supply port to open said developer supply port.

13. An apparatus according to claim 12, further comprising a projection for urging a portion to be urged provided in said covering member when said cartridge is mounted to the main assembly of the apparatus.

14. An apparatus according to claim 12, further comprising a releasing portion for releasing locking with said cartridge locking portion by elastic deformation of said covering member when said cartridge is mounted to the main assembly of the apparatus.

15. An apparatus according to claim 13, wherein said projection urges a portion to be urged provided in said covering member at a position adjacent said cover side locking portion locked with said cartridge locking portion.
